(19) United States
(12) Patent Application Publication
(10) Pub. No.: US 2026/0241836 A1
(43) Pub. Date: Aug. 20, 2026

(54) SYSTEM AND METHOD FOR AUTOMATICALLY ADJUSTING A SEAT ASSEMBLY FOR A WORK VEHICLE BASED ON TERRAIN FEATURES

(71) Applicant: Deere & Company, Moline, IL (US)

(72) Inventors: SHIBINKUMAR KRISHNAKUMAR, Pune (IN); Atique Mallabadkar, Pune (IN); Maitreyee Tambe, Pune (IN)

(21) Appl. No.: 19/055,714

(22) Filed: Feb. 18, 2025

(51) Int. Cl. B60N 2/02

(52) U.S. Cl. CPC B60N 2/0278; B60N 2/02246; B60N 2/0274; B60N 2/0277; B60Y 2200/41

(57) ABSTRACT

Disclosed herein are examples of a seating assembly for use with a work vehicle, and the pose (i.e., pitch and/or tile) of which is automatically adjusted based on the topography of a worksite being traversed. The seating assembly includes an operator seat and a positioning assembly coupled to the operator seat and configured to adjust the position of the operator seat in response to one or more control signals. Also disclosed herein are controllers configured to generate the one or more control signals. The controllers disclosed herein may be in communication with an external or internal database, and with a position tracking system configured to track the position of the work vehicle. The control signals are generated in response to the data in the external or internal database, as well as the position of the work vehicle.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD

The present disclosure generally relates to work vehicles having seating for operators during working operations, and more particularly to seating assemblies that are automatically adjustable in position for greater operator comfort on uneven terrain.

### BACKGROUND

Driving agricultural equipment in the field can be a fatigue inducing task. Particularly, the terrain at a worksite may have topographical features that position a work vehicle, and therefore also the operator of the work vehicle, at a slant or angle when the work vehicle traverses sloped terrain. This in turn means that, when the work vehicle traverses sloped terrain, the operator will be inclined with respect to the operator's center of gravity. This can cause discomfort for a vehicle operator, particularly on lengthy projects.

While this problem can be mitigated to some extent with operator seats that allow the vehicle operator to adjust seat position and angle to more fully align the operator with the operator's own center of gravity, these solutions may be inadequate where the terrain of a worksite has a topography that varies within the worksite itself, such that the impact on the position of the operator with respect to the center of gravity caused by the terrain varies as a function of the position of the work vehicle.

Therefore, there is a continuing need for improvements for seating assemblies for a work vehicle.

### BRIEF SUMMARY

Disclosed herein are examples of seating assemblies for a work vehicle, particularly adjustably positionable seating assemblies. Generally, the seating assemblies disclosed herein include an operator seat and a positioning assembly that adjustably connects the operator seat to the work vehicle, and more particularly, to the cab of the work vehicle. The positioning assembly may include one or more actuators connected to the operator seat and configured to adjust the position to the operator seat in response to changing topographical conditions of the terrain of a worksite.

The seating assemblies disclosed herein may also be used alongside and in communication with a position tracking system configured to track the position of the work vehicle within the worksite. The may allow the position of the work vehicle relative to one or more terrain features of the worksite to be determined and updated, and for the orientation and position of the work vehicle to be identified.

The seating assemblies disclosed herein may additionally be associated with a controller configured to produce and transmit control signals to the positioning assembly to control the operation of the one or more actuators. These commands may be generated in response to information obtained by the position tracking system, as well as in response to available data about the topography of the worksite.

Certain examples concern a seat assembly for a work vehicle. The seat assembly includes an operator seat, a positioning assembly adjustably comprising one or more actuators connecting the operator seat to the work vehicle, a position tracking system configured to identify the position of the seating assembly relative to a known worksite; and a controller configured to receive one or more input signals from the position tracking system and transmit, in response to the one or more input signals, one or more control signals to the positioning assembly to drive the one or more actuators to adjust the position of the operator seat.

Certain examples concern a method for operating a work vehicle having a seat assembly including an operator seat and a positioning assembly with one or more adjustable actuators assembly. The method comprises obtaining topographical data corresponding to a worksite and identifying, at a plurality of geographic locations within the worksite, a predicted pitch or a predicted tilt of a work vehicle at one or more geographic locations of the plurality of geographic locations. The method also comprises calculating, based on the predicted pitch or tilt of the work vehicle at the one or more geographic locations, a target seat pitch or target seat tilt for each of the one or more geographic locations and advancing the work vehicle to the one or more geographic locations for which target seat pitch or target seat tilt has been calculating The method also comprises adjusting the pitch or the tilt of the operator seat based on the predicted pitch or tilt of the work vehicle such that the pitch of the seat approaches the target seat pitch or the tilt of the seat approaches the target seat tilt as the work vehicle approaches the one or more geographic locations.

Certain examples concern a work vehicle. The work vehicle comprises an operator seat, a positioning assembly adjustably comprising one or more actuators connecting the operator seat to the work vehicle, and a position tracking system configured to identify the position of the work vehicle within a worksite. The work vehicle also comprises a controller in communication with a corpus of topographical data about the worksite and configured to receive one or more input signals from the position tracking system and transmit one or more control signals to the positioning assembly to drive the one or more actuators to adjust the position of the positioning assembly. The controller is associated with a computer program product configured to generate the one or more control signals based at least in part on the input from the position tracking system and the corpus of topographical data about the worksite. The control signals drive the one or more actuators to adjust the position of the operator seat from a first position to a second position different from the first position.

Numerous objects, features, and advantages of the embodiments set forth herein will be readily apparent to those skilled in the art upon reading the following disclosure in conjunction with the accompanying drawings.

### BRIEF DESCRIPTION OF THE DRAWINGS

FIG. 1 is a perspective view of a work vehicle according to one aspect of the present disclosure.

FIG. 2 is a front view and a side view of a seat assembly for the work vehicle of FIG. 1.

FIGS. 3A through 3D schematically illustrate the work vehicle of FIG. 1 under various topographical worksite conditions.

FIG. 4 is a schematic representation of the systems controlling the operation of the seat assembly of FIG. 2.

FIG. 5 is a schematic representation of a vehicle position tracking system according to one aspect of the present disclosure.

FIG. 6 is a schematic view of a controller according to one aspect of the present disclosure.

FIG. 7A is a schematic representation of the default position of the seat assembly of FIG. 2 according to one aspect of the present disclosure.

FIG. 7B is a schematic representation of the adjustment of the position of the seat assembly of FIG. 2 according to one aspect of the present disclosure.

FIG. 8 is a flowchart illustrating a method for adjusting the position of the seating assembly according to one aspect of the present disclosure.

### DETAILED DESCRIPTION OF THE INVENTION

### General Terms

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

As used herein, the terms proximal and distal refer to direction along an attached object having a free end, relative to the point of attachment. Particularly, when an object is attached at one end, the end of the attachment is the proximal end, and the free end is the distal end. The direction along the object towards the point of attachment is the proximal direction. The direction along the object towards the free end is the distal direction.

Unless explained otherwise, all technical and scientific terms used herein have the same meaning as commonly understood to one of ordinary skill in the art to which this disclosure belongs. Although methods and compounds similar or equivalent to those described herein can be used in the practice or testing of the present disclosure, suitable methods and compounds are described below. The compounds, methods, and examples are illustrative only and not intended to be limiting, unless otherwise indicated. Other features of the disclosure are apparent from the following detailed description and the claims.

Unless otherwise indicated, all numbers expressing quantities of components, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximations unless the word “about” is recited. Furthermore, not all alternatives recited herein are equivalents.

As used herein, the term “tilt” refers to the angular orientation of a work vehicle or a surface such as the ground in a direction in line with the operational direction of the work vehicle. For example, if the operational direction of a work vehicle is the forward direction, “tilt” will refer to the angular orientation of the vehicle or the ground in the front/rear direction relative to the work vehicle.

As used herein, the term “pitch” refers to the angular orientation of a work vehicle or a surface such as the ground in a direction transverse to the operational direction of the work vehicle. For example, if the operational direction of a work vehicle is the forward direction, “pitch” will refer to the angular orientation of the vehicle or the ground in the left/right direction relative to the work vehicle.

As used herein, the term “pose” in the context of a work vehicle and/or operator seat may correspond to or otherwise comprise at least a tilt and/or pitch thereof.

### Introduction to the Disclosed Technology

The present disclosure concerns seating assemblies, and particularly adjustable seating assemblies configured to adjust the pitch and/or tilt of an operator's seat in a work vehicle in response to changing terrain at a worksite. Generally, the seating assemblies disclosed herein include an operator seat and a positioning assembly that couples the operator seat to the vehicle, usually the interior of an operator cab. The seating assemblies disclosed herein are also configured to operate in response to signals from a controller associated with the work vehicle. As discussed in greater detail herein, the controller can be configured to produce control signals to automatically (that is, independent of input from the vehicle operator) adjust the position of the seating assembly.

The positioning assemblies disclosed herein generally include one or more actuators configured to extend or retract to raise or lower an end portion (for example, a front end, rear end, left end, and/or right end) of the operator seat in order to adjust the pitch and/or tilt of the operator seat, in response to the changing topographical contours of the worksite.

In some examples, a controller is also provided to control the repositioning, and particularly the tilt and/or the pitch of the disclosed seating assemblies. The controller can control the tilt and/or the pitch of the seating assemblies under a predetermined program, or in response to predictively generated target positions for the seat assembly.

In some examples, the controller can also be in communication with a database. The database can include a corpus of data, including positioning and topographical data for one or more worksites. In some examples, the corpus of data can be used to predictively generate one or more target positions to the seating assembly.

Advantageously, the adjustable seating assemblies disclosed herein provide for improved operator comfort during a work operation, by allowing the position of the vehicle operator to be continuously adjusted to correspond with the center of gravity, and to correct for differences between operator position and operator center of gravity caused by sloped terrain.

### Aspects of the Disclosed Technology

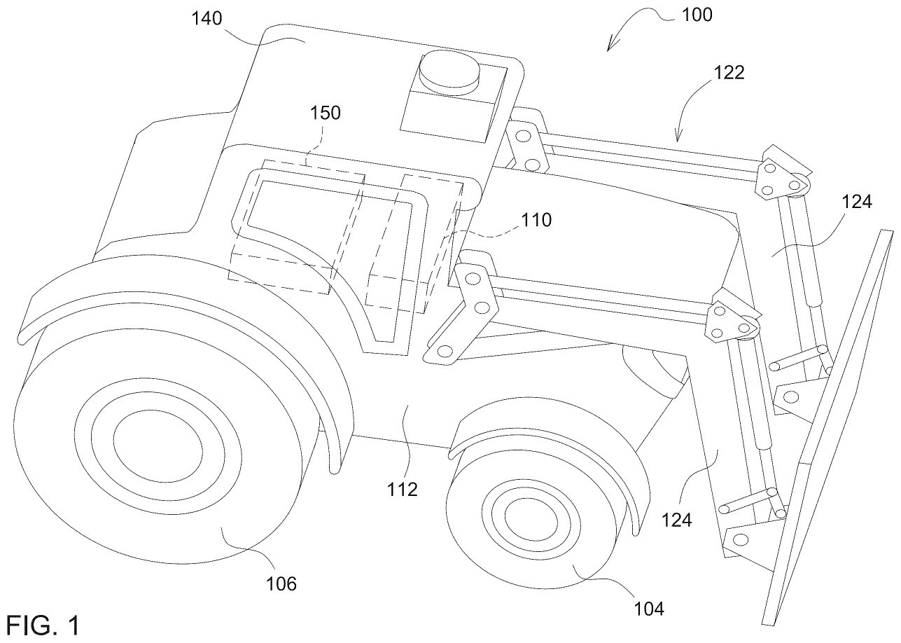

Referring now to the drawings, FIG. 1 depicts an example work vehicle 100. According to one aspect of the present disclosure, the work vehicle 100 can be a vehicle such as the skid steer shown in FIG. 1, but it will be appreciated that the tool assemblies disclosed herein can be used with other work vehicles.

The work vehicle 100 includes first and second ground engaging units 104 and 106. In some examples, the first ground engaging unit 104 and the second ground engaging unit 106 can be pairs of front and rear wheels, respectively, as shown in FIG. 1, however it will be understood that, in other examples, different kinds of ground engagement units, (for example, crawler tracks) including related first and second hydraulic travel motors can be used instead of the wheels shown in FIG. 1.

As seen in FIG. 1, the work vehicle 100 can also include a main frame 112. According to some aspects of the present disclosure, the first and second ground engaging units 104 and 106 may be left and right crawler tracks, respectively, as shown in FIG. 1.

According to one aspect of the present disclosure, the work vehicle 100 includes a working assembly 122 extending alongside and forward from the main frame 112. The working assembly 122 includes one or more actuators 124 extending between the main frame 112 and a working tool, such as the tool assembly described in greater detail below.

An operator cab 140 may be located on the main frame 112, as illustrated in FIG. 1. The operator cab 140 and the working assembly 122 may both be mounted on the main frame so that the operator cab 140 faces in a working direction of the work vehicle 100 (that is, towards the front of the work vehicle 100).

As shown in FIG. 1, the operator cab 140 can include a seat assembly 150, located within the operator cab 140 and positioned such that a vehicle operator in the seat assembly 150 can easily access the control station 110, and any other vehicle controls necessary for vehicle operation.

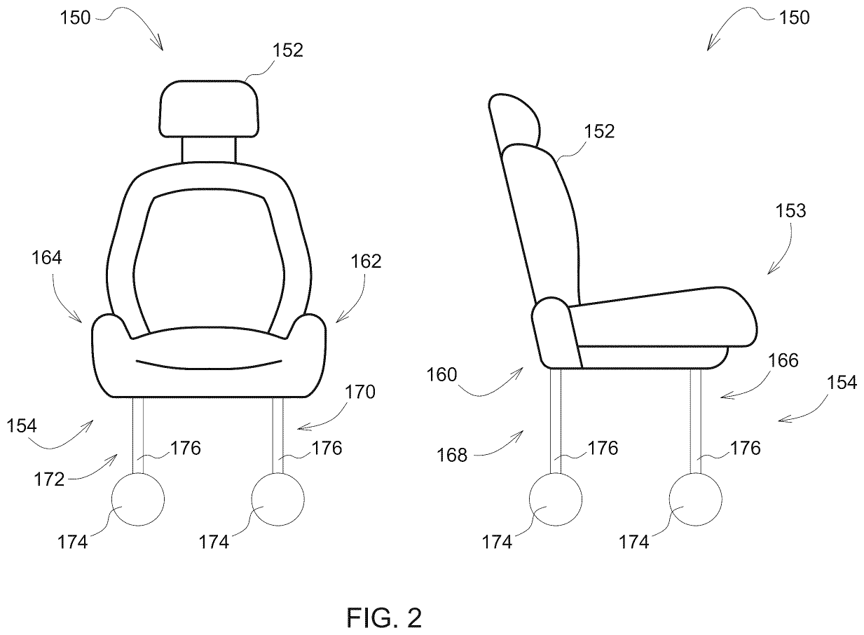

The seat assembly 150 is illustrated in greater detail in FIG. 2, and includes an operator seat 152 and a positioning assembly 154 disposed between the operator seat 152 and the structure of the work vehicle 100, such as the floor of the operator cab 140 illustrated in FIG. 2. The operator seat 152 can include a front end portion 158 disposed towards the front of the operator cab 140 (and therefore towards the front of the work vehicle 100), and a back end portion 160 disposed away from the front of the operator cab 140 (and therefore away from the front of the work vehicle 100), as shown in FIG. 2B. The operator seat 152 can also include a left end portion 162 and a right end portion 164, positioned towards a left side (L) and right side (R) of the operator cab 140, as illustrated in FIG. 2A.

The positioning assembly 154 can secure the operator seat 152 to the floor of the operator cab 140, as shown in FIGS. 2A and 2B, and as illustrated, can include one or more actuator assemblies. For example, as shown in FIG. 2B, the positioning assembly 154 can include a front actuator assembly 166 positioned below the front end portion 158 of the operator seat 152 and a back actuator assembly 168 positioned below the back end portion 160 of the operator seat 152. Likewise, as shown in FIG. 2A, the positioning assembly 154 can include a left actuator assembly 170 positioned below the left end portion 162 of the operator seat 152 and a right actuator assembly 172 positioned below right end portion 164 of the operator seat 152.

According to one aspect of the present disclosure, the actuator assemblies of the positioning assembly 154 (that is, the front actuator assembly 166, the back actuator assembly 168, the left actuator assembly 170, and the right actuator assembly 172) each comprise a motor 174 (for example, an electrical motor) and a motor driven actuator 176 that is movable between an extended position and a retracted position by the motor 174 with which it is associated with to extend or retract.

When the actuators 176 of the actuator assemblies 166, 168, 170 and 172 are extended, the portion of the operator seat 152 to which they are attached can be raised and lowered. Thus, by extending and/or retracting the actuators 176 of the front actuator assembly 166 and the back actuator assembly 168, the front end portion 158 of the operator seat 152 and the back end portion 160 of the operator seat 152 can be correspondingly raised and/or lowered as well. This allows the position of the front end portion 158 of the operator seat 152 and the back end portion 160 of the operator seat 152 to be adjusted by extending and/or retracting the actuators 176 of the front actuator assembly 166 and the back actuator assembly 168, thereby adjusting the tilt of the operator seat 152.

Likewise, by extending and/or retracting the actuators 176 of the left actuator assembly 170 and the right actuator assembly 172, the left end portion 162 of the operator seat 152 and the right end portion 164 of the operator seat 152 can, respectively, be raised and/or lowered. This allows the elevation of the left end portion 162 and the right end portion 164 of the 152 to be adjusted by extending and/or retracting the actuators 176 of the left actuator assembly 170 and the right actuator assembly 172, thereby adjusting the pitch of the operator seat.

While FIGS. 2A and 2B show a positioning assembly 154 having four actuators (namely, the front actuator assembly 166, the back actuator assembly 168, the left actuator assembly 170, and the right actuator assembly 172 shown), it will be appreciated that a different number of actuators may be included. For example, the positioning assembly 154 could, if fewer degrees of positional control are required, include correspondingly fewer actuators (for example, a positioning assembly 154 that only needed to control the tilt of the operator seat 152 could utilize only a front actuator assembly 166 and a back actuator assembly 168). Likewise, if additional degrees of positional control, additional actuators (that is, more than four actuators) can be included.

It will also be appreciated that, while the actuator assemblies 166, 168, 170, and 172 described herein include a motor 174 (for example, an electrical motor) and a motor-driven actuator 176, different actuator mechanisms may be used in lieu of or in addition to the electrical motor 174 and the motor driven actuator 176. For example, the actuator assemblies 166, 168, 170, and 172 can include pneumatic or hydraulic actuators, or any other actuator mechanisms suitable for selectively raising and/or lowering the operator seat 152 or end portions of the operator seat 152.

According to some aspects of the present disclosure, the work vehicle 100 can also include or be associated with a position tracking system 200, suitable for locating the work vehicle 100 within the worksite. The position tracking system 200 disclosed herein can be associated with or in communication with the seat assembly 150 and/or a controller configured to control the operation of the seat assembly 150, as discussed in greater detail herein.

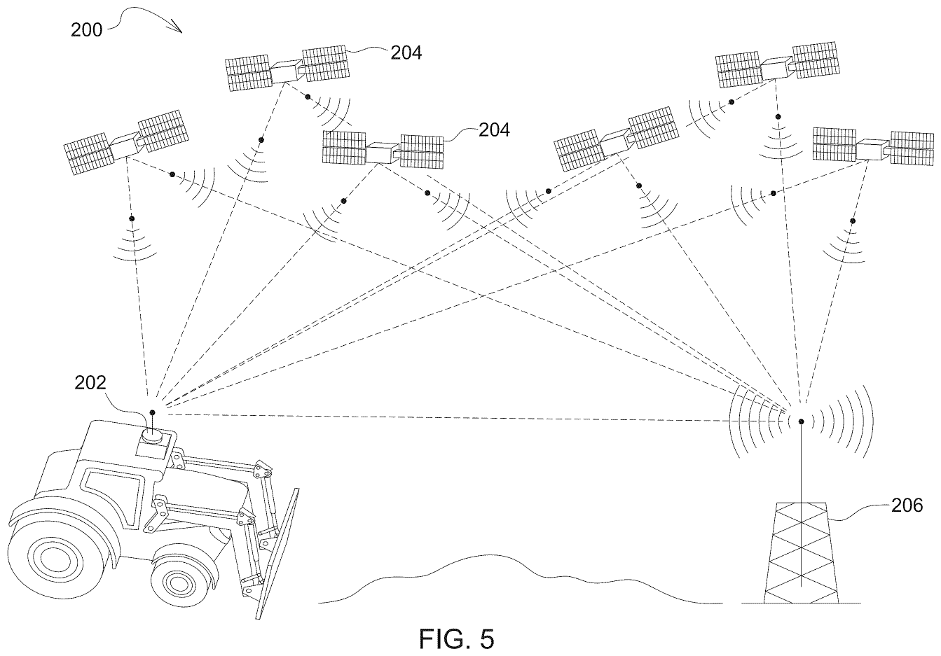

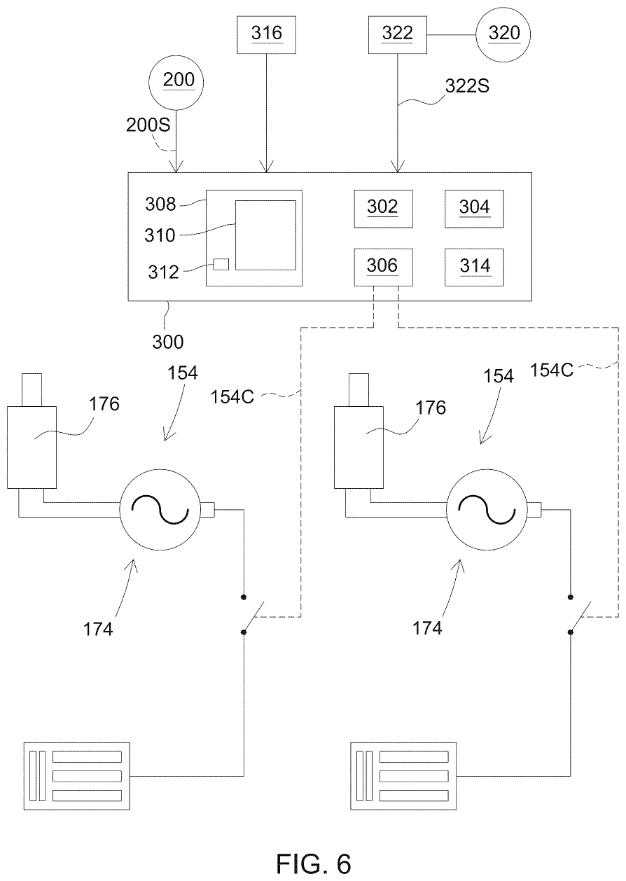

According to some aspects of the present disclosure, the position tracking system can be a Global Navigation Satellite System (GNSS), such as that shown in FIG. 5. The GNSS 200 can comprise a receiver 202 configured to receive signals transmitted by one or more satellites 204. The data received by the receiver 202 can be used to triangulate the position of the work vehicle 100 to which the position tracking system 200 within the work site. The signals from the one or more satellites 204 can be used to triangulate the position of the receiver 202 (and thus the 100 with which the receiver 202 is associated), and more particularly, the position of the receiver 256 relative to various geographic features of the worksite.

In some examples GNSS 200 can be associated with or used in tandem with a ground based communication unit 206 (sometimes called a base station), such as the radio transmitter 206 illustrated in FIG. 5. As will be appreciated by those skilled in the art, signals from the one or more satellites 204 can be subject to atmospheric interference, and advantageously, the ground based communication unit 206 can provide corrections to such signals, or to preliminary position information based on such signals. Particularly, the ground based communication unit 206 can be simultaneously in communication with the one or more satellites 204 and with the receiver 202 to provide a “real time kinematic correction” (“RTK correction”) to the preliminary positioning information based on the signal from the one or more satellites 204. More specifically, as is understood to those skilled in the art, the ground based communication unit 206 can correct errors resulting from the atmospheric transmission of signals from the one or more satellites 204 to the receiver 202. In some specific examples, the ground based communication unit 206 working in tandem with the one or more satellites 204, as discussed herein, can position the work vehicle 100 within the work site to an accuracy of less than 1 inch.

Advantageously, when data is available regarding the topographical and/or geographical features of the work site, the position tracking system 200 can associate the position of the vehicle with the topographical and/or geographical conditions of the worksite at the vehicle location. As is discussed further herein, this correlation of the location of the work vehicle 100 with the terrain features (that is, the topographical and/or geographical features) of the worksite further allows for the position and/or orientation of the work vehicle 100, and therefore of the seat assembly 150 associated with the work vehicle 100, to be determined as a function of the position of the work vehicle 100 within the worksite. In turn, this allows for one or more target position parameters for the seat assembly 150 to be calculated and/or predictively generated as a function of the position of the work vehicle 100 within the worksite, as discussed in greater detail herein.

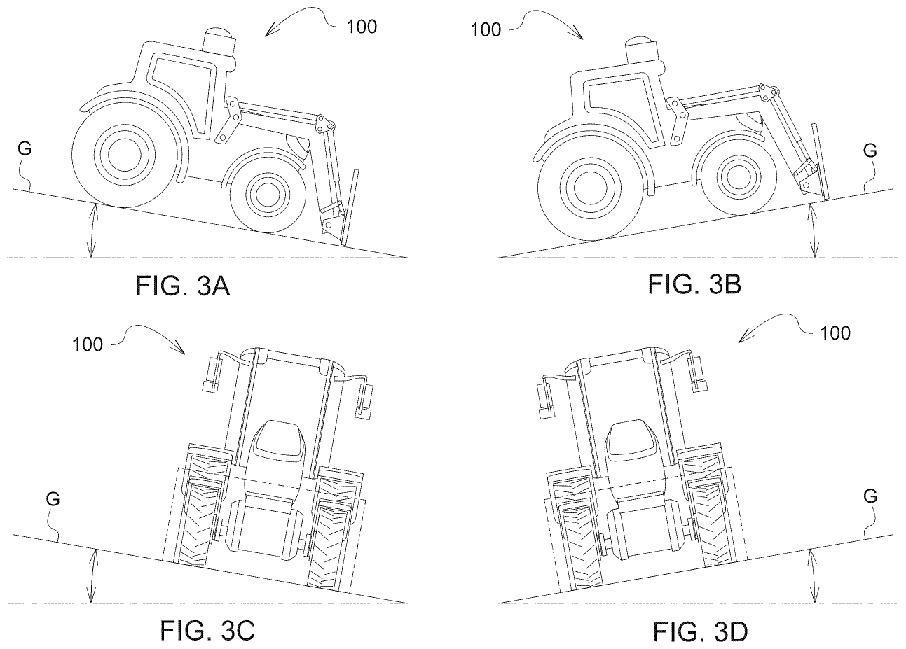

For example, as illustrated in FIGS. 3A-3D, the work vehicle 100 can be operated within a worksite at which the ground, G, has a slope or an incline. When the work vehicle 100 is at a worksite where the ground, G, slopes downward in a forward direction, as illustrated in FIG. 3A, a vehicle operator will sit in a position in which they are tilted forward of their center of gravity. In such examples, it may be advantageous to develop a target seat position in which the seat is moved rearwards of a “neutral” position to compensate for the forward lean imparted by the terrain. Likewise, when the work vehicle 100 is at a worksite where the ground, G, slopes upward in a forward direction as illustrated in FIG. 3B, the vehicle operator will sit in a position in which they are tilted backward from their center of gravity. In such examples, it may be advantageous to develop a target seat position in which the seat is moved forwards of a “neutral” position to compensate for the rearward lean imparted by the terrain. Similarly, the adjustable target seat position can be used to accommodate for changes in the user position resulting from a transverse (that is towards the left or right side of the work vehicle), such as that indicated in FIGS. 3C and 3D, slope by similarly adjusting the position of the seating assembly to correct for the left or right lean imparted by the terrain.

According to one aspect of the present disclosure, where the terrain topography of the worksite varies as a function of position, it may be advantageous to use the position tracking system 200 as previously described to identify specific positions of the work vehicle 100 within the worksite, and/or to predict one or more future positions of the work vehicle 100 within the worksite.

While discussion has been made regarding a vehicle incorporating a position tracking system 200, it will be understood that other methods of identifying and/or tracking the position of the work vehicle 100 within the worksite may be used in lieu of or alongside the GNSS system 200 as previously introduced, such as radio-based or inertial position tracking systems, the use of which are known to those skilled in the art.

Also disclosed herein are examples of controllers suitable for use seat assembly 150 and the work vehicle 100 previously described. For example, a controller 300 according to one aspect of the present disclosure is shown in FIG. 10.

The controller 300 includes or may be associated with a processor 302, a computer-readable medium 304, a database 306, and an input/output module or control panel 308 having a display 310. The control panel 308 may be a part of the control station 110 in the operator cab 140. An input/output device 312, such as a keyboard, joystick, or other user interface, can be provided so that a human vehicle operator may input instructions to the controller 300. It is understood that the controller 300 described herein may be a single controller having the described functionality, or it may include multiple controllers wherein the described functionality is distributed among the multiple controllers. Some or all of the controllers may be located at a location other than the work vehicle and be connected wirelessly.

Various operations, steps or algorithms as described in connection with the controller 300 can be embodied directly in hardware, in a computer program product 314 such as a software module executed by the processor 302, or in a combination of the two. The computer program product 314 can reside in RAM memory module, flash memory module, ROM memory module, EPROM memory module, EEPROM memory module, registers, hard disk, a removable disk, or any other form of computer-readable medium 304 known in the art. An exemplary computer-readable medium 304 can be coupled to the processor 302 such that the processor 302 can read information from, and write information to, the memory/storage medium. In the alternative, the medium can be integral to the processor. The processor and the medium can reside in an application-specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices, and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

According to one aspect of the present disclosure, illustrated in FIG. 3, the controller 300 is configured to receive one or more input signals and to produce and transmit one or more output signals in response to or based in part on the input signals.

Particularly, a user interface 316 can be associated with the controller 300. The user interface 316 may be associated with the control station 110 of the work vehicle 100, previously described, or with a separate device, such as a mobile device, so that a user or a remote user can enter user input such as one or more signals to the controller 300 through the user interface 316.

According to one aspect of the present disclosure, the database 306 of the controller 300 can also be associated with a corpus of topographical data 320 relating to the worksite. The topographical data 320 can include information such as elevation, pitch, tilt, and slope of the ground at various points at the worksite, and in some cases can include a map, such as a prerecorded terrain map, of the worksite. The topographical data 320 can also include additional information, such as soil type and firmness that may need to be considered during the preparation of a work plan.

The topographical data 320 associated with the database 306 may be obtained from any suitable source. For example, if topographical survey data exists of the terrain profile of a worksite of sufficient quality and detail, the corpus of topographical data 320 can include this data. Additionally, where a worksite has been previously traversed by one or more work vehicles, and where such vehicles are instrumented with one or more sensors capable of measuring relevant topographical data such as height, tilt, pitch, and slope of the ground at various locations within the worksite, this previously measured data from the previous work operations can be included in the corpus of topographical data 320 in addition to or in lieu of previous topographical survey data.

Additionally, in some cases, the topographical data may be procedurally generated or calculated based on simulated data and relevant modeling techniques.

In some cases, the topographical data 320 is stored externally to the controller, such as in a remote or cloud based data storage medium 322. In such examples, the topographical data can be transmitted to the controller 300 (and more particularly the database 306 of the controller 300) by remote storage signal 322S at the time a work project begins. In such examples, the vehicle operator, a work supervisor, or some other person can identify the specific worksite and selectively download the topographical data associated with the selected worksite to the database 306 of the controller 300. Alternatively, the worksite may be identified by measuring the position of the work vehicle 100 using the GNSS 254, and topographical data for the worksite can be automatically loaded.

In some cases, the topographical data 320 can be loaded into the database 306 of the controller 300 in advance of the work project, and in such cases, there may be no need to transmit topographical data from the remote or cloud based data storage medium 322 to the controller 300.

According to some aspects of the present disclosure, the controller 300 can receive signals from one or more of the instruments previously introduced. In particular, the controller 300 can receive a vehicle position input signal 200S from the position tracking system 200 (for example, from the receiver 202, subject to any correction received from the ground based communication unit 206). The vehicle position input signal 200S can include absolute position date (for example, geographical coordinates) or relative data (such as position of the work vehicle 100 relative to identified features at the worksite), and can be used to correlate the position of the work vehicle 100 with the identified and/or predicted terrain features at the worksite.

This correlation between the position of the work vehicle 100 within the worksite, and the topographical features of the worksite that correspond to the identified position of the work vehicle 100 within the worksite can be used to identify a target seat position profile, which correlates the tilt and/or pitch of the operator seat 152 based at least in part on the topographical features within the worksite. For example, the various topographical features within the worksite (and accordingly, the geographical and/or relative positions as identified by the position tracking system 200 that are associated with the topographical features within the worksite) can be associated with a predicted vehicle orientation at one or more of the positions within the worksite for which there is topographical data. These predicted vehicle orientations can include tilt and/or pitch information for a vehicle at the one or more positions within the worksite for which there is topographical data. Using the predicted vehicle orientations (that is, the predicted tilt and/or pitch of the vehicle) at the one or more positions, and given a target seat orientation, the controller 300 can generate one or more seat assembly control signals 150C to drive the positioning assembly 154 to adjust the operator seat 152 towards the target seat position.

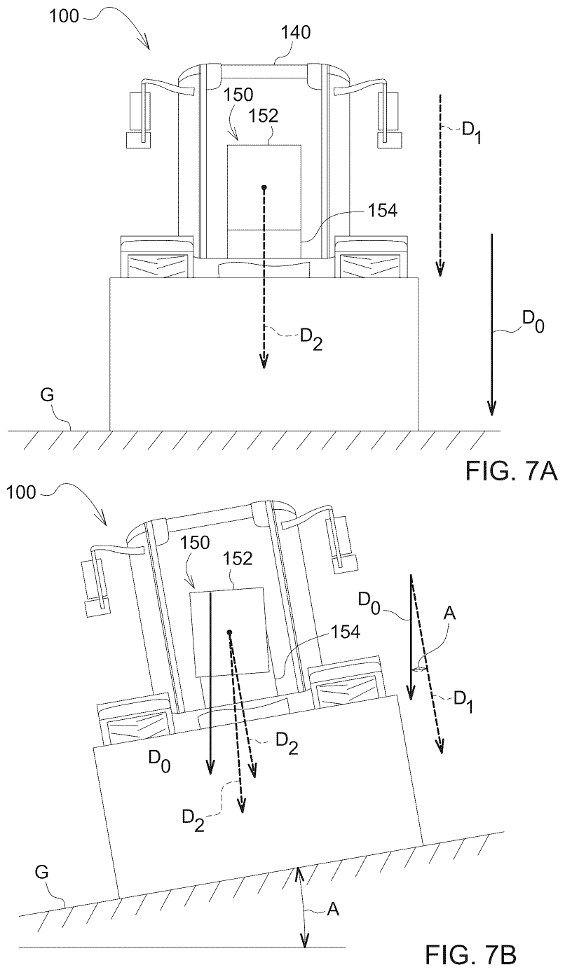

For example, as illustrated in FIGS. 7A and 7B, the work vehicle 100 can operate on the ground G of a worksite. Within the context of the worksite, the direction “down” may be defined in reference to the direction of gravitational pull, as indicated in FIGS. 7A and 7B by the directional arrow D₀. However, because the work vehicle 100 is positioned atop the surface of the ground G, the frame of reference of the vehicle, “down” may be determined as a function of the relationship between the vehicle and the ground, such that using the vehicle as the frame of reference, the “vehicular down” work vehicle 100 will be oriented normal to the ground, as indicated by the directional arrow D₁ in FIGS. 7A and 7B Likewise, “down” from the frame of reference of a vehicle operator located in the operator seat 152 may be determined as a function of the operator seat, indicated in FIGS. 7A and 7B by directional arrow D₂. It will be appreciated that, because the seat assembly 150 is mounted within the operator cab 140 of the work vehicle 100, as shown in FIG. 1, absent any adjustment to the orientation of the operator seat 152 by the positioning assembly 154, such as previously discussed, operator down (D₂) and vehicle down (D₁) will be the same direction.

It will also be appreciated that comfort of the vehicle operator may be at its highest when the operator down D₂ extends parallel to gravitational down, as indicated by D₀, and that when the angle between D₂ and D₀ becomes too great, vehicle operator discomfort may increase. It is therefore advantageous to adjust the seat assembly 150 to reduce the angle between O₁ and D₀, for example, by adjusting the position of the operator seat 152 using the positioning assembly 154 as previously described.

Where the worksite consists of flat ground, such as that represented in FIG. 7A, D₀ and D₁ are directionally the same (that is, the direction of gravitational pull on the work vehicle 100 (and thus also of the vehicle operator) runs parallel to a line normal to the ground. In such examples, it may not be necessary to provide any angular adjustment to the position of the operator seat 152, because D₀, D₁, and D₂ are all parallel (that is to say, gravitational down, vehicle down, and operator down are all the same direction), and so comfort of the vehicle operator may not be adversely impacted by the topography of the ground (G).

However, where the worksite consists of sloped or angled ground (G), such as that represented in FIG. 7B, D₀ and D₁ are separated by an angle (A) determined by the slope of the ground (G). Because, absent adjustment of the position of the operator seat 152 by the positioning assembly 154, operator down and vehicle down are the same direction, D₂ will also be separated from D₀ by the angle A. As previously discussed, where there is a mismatch between operator down D₂ and gravitational down D₁, this position of the operator seat 152 may cause operator discomfort.

To relieve this discomfort, the positioning assembly 154 may be used to adjust the position of the operator seat 152 such that the angle between D₂ and D₀ is reduced or eliminated. According to one aspect of the present disclosure, this can be accomplished by identifying, based on the topography of the ground (G) at a given location within the worksite, what position of the operator seat 152 will result in the angle between D₂ and D₀ being reduced minimized, sometimes called the target seat position. For example, as shown in FIG. 7B, the angle between D₂ and D₀ can be reduced by raising the right end portion 164 of the operator seat 152 and lowering the left end portion 162 of the operator seat 152, and so a target seat position (including a target seat pitch component) for the illustrated topography can be identified in which the right end portion 164 of the operator seat 152 has been sufficiently raised and the left end portion 162 of the operator seat 152 has been sufficiently lowered that D₂ and D₀ are the same or substantially the same.

It will be appreciated that, while the discussion above and the example shown in FIGS. 7A and 7B show a worksite where the vehicle is on ground having a slope extending transverse to the driving axis work vehicle 100, which necessitates an adjustment of the pitch of the operator seat 152 by raising and/or lowering the right end portion 164 and the left end portion 162 of the operator seat 152, similar principles can also be used to adjust the tilt of the operator seat 152 to compensate for ground that slopes along the driving axis of the work vehicle, and that in such cases, the target seat position will include a target seat tilt component. It will be further appreciated that, if the positioning assembly 154 includes actuators to adjust both the pitch and the tilt of the operator seat 152 (for example, by raising and/or lowering the front end portion 158, the back end portion 160, the left end portion 162, and the right end portion 164 of the operator seat 152), the target seat position can include both a target seat tilt component and a target seat pitch component.

According to some aspects of the present disclosure, where topographical data is available for the ground at multiple positions of a worksite, multiple target seat positions can be provided that adjust for the topography at the multiple positions for which topographical data is available. It will be appreciated that in some cases, this data is available in the form of a pre-generated program for seat position as a function of the location of the work vehicle 100, either stored with or separately from the topographical site data previously discussed. In such examples, the pre-generated program can

It will also be appreciated that in other cases, the target seat position for a location within the worksite can be predictively generated based on available topographical data for that position, for example, as part of the computer program product 314 of the controller 300. In such examples, the program of seat positions as a function of the location of the work vehicle 100 within the worksite can be generated by the controller 300 in advance of the work operation or during the work operation in response to vehicle position, orientation, and travel speed.

According to one aspect of the present disclosure, the position tracking system 254 (for example, the GNSS 254 previously introduced) can be in communication with the controller 300, and configured to transmit a 200S 254S to the controller 300, the 200S 254S containing data regarding the position of the work vehicle 100, the position tracking system 200, or the components thereof to the controller 300. The 300 can, in such examples, be configured to identify a position-specific target seat position based on the identified position of the work vehicle 100, and transmitted to the controller 300 in the Vehicle position input signal 200S. Based at least in part on this data, the controller 300 can then generate the computer program product 314, including the program of seat positions as a function of position of the work vehicle 100 within the worksite. The computer program product 314 can then be transmitted to the positioning assembly 154 by positioning assembly control signal 154C, which drives the positioning assembly 154, and particularly the actuators of the positioning assembly 154 (for example, the front actuator assembly 166, the back actuator assembly 168, the left actuator assembly 170, and the right actuator assembly 172 previously introduced) to a target configuration that causes the actual position of the operator seat 152 to approach the target position of the operator seat 152.

As previously discussed, the computer program product 314 described herein can be generated remotely and/or ahead of time, either predictively or using a previously generate program of target seat positions as a function of the location of the work vehicle 100 within the worksite. For example, the computer program product 314 and/or the program of target positions for the operator seat 152 based on the position of the work vehicle 100 within the worksite can be associated with an engineering plan for a work site that is prepared ahead of time and correlates desired positions of the operator seat 152 to one or more previously identified positions within the work site. It will also be understood, however, that at least a portion of the computer program product 314 can be updated or adapted based on ad hoc user input, for example through the user interface 316 of the controller 300. For example, a vehicle operator may manually adjust the position of the operator seat 152 during the work operation to improve user comfort, to improve visibility, or for any other reason. In such examples, any manual change implemented by the vehicle operator can be recorded and the computer program product 314 (for example, the stored or predictively generated program of seat positions) can be updated in response to the input of the vehicle operator.

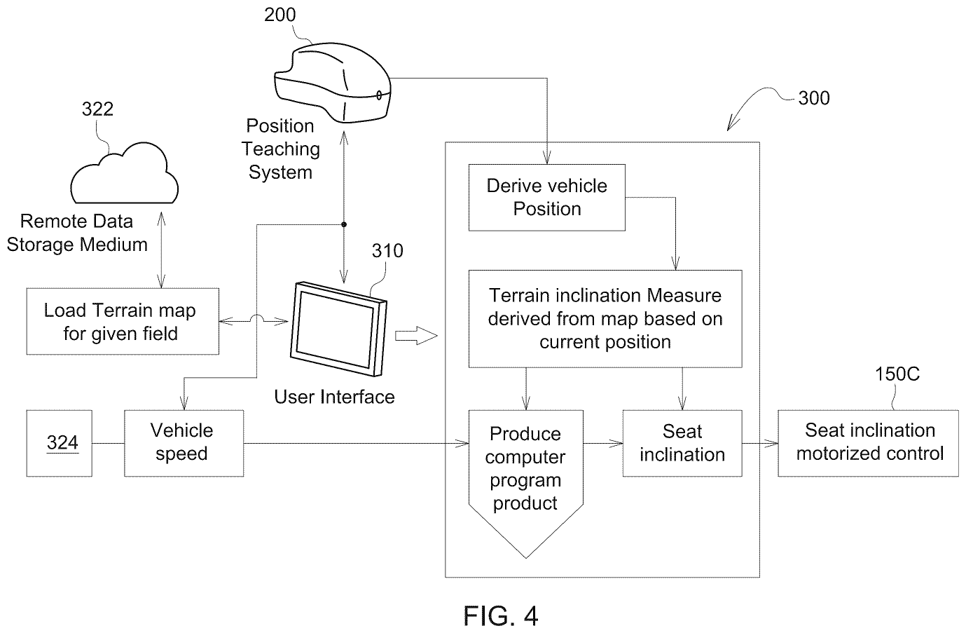

A schematic of the interrelation of the various aspects of the present disclosure is presented in FIG. 4. As shown in FIG. 4 the controller 300 can have access to vehicle position data as obtained from the position tracking system 200 with which it is in communication. Likewise, the controller 300 can have access to external data topographical data about the worksite terrain from the remote data storage medium 322 with which it is also in communication. In some cases, this data may be presented to the vehicle operator in some format through the user interface 316 which may be in communication with the position tracking system 200, the controller 300, and the remote data storage medium 322, but it will be appreciated that, in cases where no user input is needed to generate the computer program product 314 including the program of seat position as a function of the location of the work vehicle 100, displaying the position and terrain data to the vehicle operator may be omitted.

With continued reference to FIG. 4, the controller 300 may also have access to data about the speed of the work vehicle 100. In some examples, this may be derived from data available through the position tracking system 200. In other examples, it may be obtained from one or more vehicle speed sensors 324 which are in communication with the controller 300.

According to one aspect of the present disclosure, the controller 300 can use the identified vehicle position and the known topographical data for the worksite to identify terrain inclination for one or more locations at the worksite. As previously discussed, this may be data previously available and correlated with the map of the worksite or may be calculated by the controller based on the available topographical data and the available information about the position of the work vehicle 100.

In some examples, information about the position of the work vehicle 100, as well as information about the bearing and speed of the work vehicle 100 can be used to predictively identify both the predicted next location of the work vehicle 100, and the terrain inclination of the worksite at the predicted next location of the work vehicle 100.

Information about the inclination of the worksite of the predicted next location of the work vehicle 100 can be used to identify or predict a target seat position associated with the predicted next location of the work vehicle 100 within the worksite and subsequently used to generate an actuator control signal 150C.

Also disclosed herein are methods of generating and executing a program of target seat positions as a function of the position of the work vehicle 100 within the worksite.

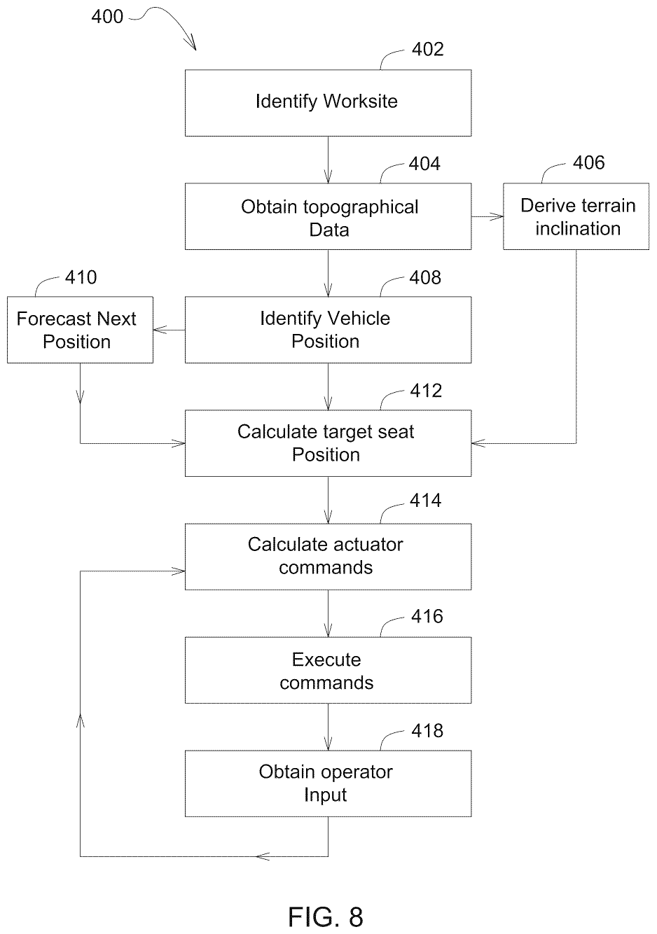

For example, FIG. 8 outlines a seat position control method 400 according to one aspect of the present disclosure. As illustrated in FIG. 8, the seat position control method 400 can begin with the identification of the worksite, as represented in worksite identification step 402 in FIG. 8. As previously discussed, the identification of the worksite can be done automatically, for example, by comparing the measured position of the work vehicle 100 as measured by the position tracking system 200 with known worksite locations. The identification of the worksite can also be done manually, for example by a project manager or vehicle operator.

With the worksite identified, the seat position control method 400 further comprises obtaining topographical data corresponding to the identified worksite, as represented in topographical data obtaining step 404 in FIG. 8. As previously discussed, this topographical data can include data on the height, pitch, slope, and any other relevant data for the topography of the worksite from which predicted vehicle orientation (and thus target seat predictions) can be calculated. The data obtained in this step may include such information for a plurality of geographic locations within the worksite. This topographical data may be stored locally, for example in the database 306 stored in memory of the controller 300, or may be stored remotely, for example on the remote data storage medium 322 with which the controller is in communication.

The available topographical data for the identified worksite can be used to further calculate the terrain inclination at a plurality of geographic locations within the worksite. More specifically the available topographical data can be used to predict the pitch or tilt of a work vehicle on the identified terrain, based on the calculated terrain inclination, at the plurality of geographical locations, with a predicted pitch or tilt derived for each location of the plurality of geographic locations, as indicated in FIG. 8 as terrain inclination derivation step 406. In some examples, the calculation of predicted terrain inclination may be done in advance of the work operation, such that the predicted terrain inclination (and accordingly the predicted pitch and/or tilt of a vehicle at such a location) may be available for the plurality of geographic locations within the worksite in advance of the commencement of the work product. In such cases, this information may be obtained along with the available topographical data and need not be subsequently derived.

According to some aspects of the present disclosure, the seat position control method 400 can also include identifying the position of the work vehicle 100 within the worksite identified in the worksite identification step 402. This is indicated in FIG. 8 as a vehicle position identification step 408. The identification of the position of the work vehicle 100 within the worksite may for example be accomplished using any of the position tracking systems 200 previously identified.

In some cases, the seat position control method 400 may also include forecasting one or more subsequent vehicle positions, as indicated in position forecasting step 410 in FIG. 8. More particularly, if the position of the work vehicle 100 is known, along with for example the measured velocity, acceleration, direction of motion, etc., of the work vehicle 100, it is possible to extrapolate one or more future positions of the vehicle within the worksite.

Because the position of the vehicle within the worksite is known, and in some cases, the future position of the vehicle within the worksite is known, and because the locations of the vehicle within the worksite have been correlated with a predicted spatial orientation of the vehicle (including elevation, pitch, and tilt of the vehicle), the seat position control method 400 can further include calculating one or more target seat positions for the operator seat 152 to optimize user comfort, as previously described, corresponding to the current and/or one or more predicted future positions of the work vehicle within the worksite. This is illustrated in FIG. 8 as target seat position calculation step 412. It will be appreciated that, depending on the data available and used to calculate present and future vehicle positions, the target seat position can be calculated for a position presently occupied by the work vehicle 100, as well as one or more positions that the work vehicle 100 is expected to occupy based on its present location and current velocity.

Because the current position of the operator seat 152 will be known or obtainable from the position of the actuator assemblies (for example, the actuator assemblies 166, 168, 170, and 172 previously described), and because one or more target positions for the operator seat 152 have been identified in the target seat position calculation step 412, the seat position control method 400 can further include calculating one or more actuator commands that will extend and/or retract one or more of the actuator assemblies to bring the operator seat 152 closer to one or more of the target positions of the operator seat 152. This is represented in FIG. 8 as an actuator command calculation step 414.

The actuator commands calculated in the actuator command calculation step 414 can then be executed (for example, by transmitting one or more one or more seat assembly control signals 150C to the positioning assembly 154 to drive the actuators to bring the operator seat 152 from its present position to the target position, as indicated in FIG. 8 by command execution step 416. It will be understood that, in cases where the target position for the operator seat 152 corresponding to the current position of the work vehicle 100 differs from the present position of the operator seat 152, the actuator commands calculated in the actuator command calculation step 414 can be executed immediately. It will also be appreciated that, in other examples, the commands may be associated with a predicted future position of the work vehicle 100. In such examples, the commands may be executed only after the work vehicle 100 has been advanced to the predicted future position with which the commands are associated.

It will be appreciated that the method disclosed herein may be performed with or independently of input from the vehicle operator or project supervisor. That is, the identification of the worksite, the identification of vehicle position, the determination of one or more target seat positions can be automatically performed without the need for further human input, or may be performed with input and guidance from a human operator.

Optionally, the seat position control method 400 may include a user adjustment step 418, as shown in FIG. 8. In cases where the vehicle operator retains some manual control over the position of the seat, and determines that a further adjustment to the seat position is required for optimizing comfort, these further adjustments can be recorded and communicated to the controller 300 (and particularly to the algorithm that produces target positions for the operator seat 152 as a function of the location of the work vehicle 100 within the worksite. It will be appreciated that these adjustments may be taken into consideration in further calculations of target positions for the operator seat 152 (that is, they may factor as a further input into the target seat position calculation step 412 previously discussed).

In this way, automated and/or predictive adjustments to the position of the operator seat in a work vehicle can be made in response to terrain features at a worksite and a predictive model and/or simulator can be used to develop and/or update programs of target seat positions. This may alleviate many of the comfort and fatigue problems that result from a vehicle operator being seated at an incline with respect to their center of gravity for extended periods of time.

Thus, although there have been described particular embodiments of a new and useful invention herein, it is not intended that such references be construed as limitations upon the scope of this invention except as set forth in the following claims.

1. A method for operating a work vehicle having an operator seat and a seat positioning assembly with one or more adjustable actuators, the method comprising:
obtaining topographical data corresponding to an area being traversed or to be traversed by the work vehicle;
tracking vehicle movements and a geographic location of the work vehicle as it traverses the area, and predicting subsequent geographic locations of the work vehicle based thereon;
predicting a respective pose of the work vehicle for each predicted subsequent geographic location within the area, based on the obtained topographical data;
calculating, based on the predicted pose of the work vehicle at each of the predicted subsequent geographic locations, a corresponding target seat pose; and
automatically adjusting a pose of the operator seat, via the one or more adjustable actuators, based on the corresponding target seat pose as the work vehicle approaches each geographic location.

2. The method of claim 1, wherein the pose of the work vehicle comprises a pitch and/or a tilt responsive to the corresponding topography of the area being traversed.

3. The method of claim 1, wherein the target seat pose is calculated using a predictive model.

4. The method of claim 3, wherein the predictive model is developed over time based on input data sets comprising the topographical data of one or more worksites at which work was previously performed, and the corresponding pose of work vehicles and associated operator seats at each of various location within the one or more worksites.

5. The method of claim 3, further comprising modeling one or more target seat positions based on a corpus of data generated using a simulator and adjusting the predictive model in response to the one or more target seat positions.

6. The method of claim 1, wherein the method is performed independent of input from a vehicle operator.

7. The method of claim 1, wherein the topographical data is obtained from a database containing a corpus of data including the topographical data for each of a plurality of worksites.

8. The method of claim 7, wherein the topographical data is a prerecorded terrain map of the current worksite.

9. The method of claim 8, wherein the prerecorded terrain map is generated by position data recorded from previous work operations at the worksite.

10. The method of claim 7, wherein the database further includes one or more target seat positions correlated with the topographical data, and wherein the one or more input signals are generated in response to the target seat positions.

11. A seat assembly for a work vehicle, comprising;
an operator seat;
a positioning assembly adjustably comprising one or more actuators connecting the operator seat to the work vehicle;
a position tracking system configured to identify the position of the seating assembly relative to a known worksite; and
a controller configured to direct performance of the steps in the method of claim 1.

12. The seat assembly of claim 11, wherein the one or more actuators are motors configured to adjust the position of the positioning assembly.

13. The seat assembly of claim 11, wherein the one or more actuators include a front actuator, positioned towards a front end portion of the positioning assembly and a back actuator positioned towards a back end portion of the positioning assembly, and wherein the front actuator is configured to raise and lower a front end of the operator seat and the back actuator is configured to raise and lower a rear end of the operator seat.

14. The seat assembly of claim 13, wherein the control signals drive the front actuator and the back actuator to extend or retract to adjust a pitch of the operator seat in response to the position of the seating assembly.

15. The seat assembly of claim 11, wherein the one or more actuators include a left actuator, positioned towards a left end portion of the positioning assembly and a right actuator positioned towards a right end portion of the positioning assembly, and wherein the left actuator is configured raise and lower a left end of the operator seat and the right actuator is configured to raise and lower a right end of the operator seat.

16. The seat assembly of claim 15, wherein the control signals drive the left actuator and the right actuator to extend or retract to adjust a tilt of the operator seat in response to the position of the seating assembly.

17. The seat assembly of claim 11, further comprising a database in communication with the controller, wherein the database contains a corpus of data including topographical data regarding the worksite.

18. The seat assembly of claim 17, wherein the topographical data is a prerecorded terrain map generated by position data recorded from previous work operations at the worksite.

19. The seat assembly of claim 17, wherein the database further includes one or more target seat positions correlated with the topographical data, and wherein the one or more input signals are generated in response to the target seat positions.

20. A work vehicle comprising the seat assembly of claim 11.
